(19) United States
(12) Patent Application Publication
(10) Pub. No.: US 2016/0091525 A1
(43) Pub. Date: Mar. 31, 2016

(54) ACCELERATION SENSOR

(71) Applicant: HITACHI, LTD., Tokyo (JP)

(72) Inventors: Takashi OSHIMA, Tokyo (JP); Atsushi ISOBE, Tokyo (JP); Yuudai KAMADA, Tokyo (JP); Noriyuki SAKUMA, Tokyo (JP); Yuki FURUBAYASHI, Tokyo (JP)

(73) Assignee: HITACHI, LTD.

(21) Appl. No.: 14/856,537

(22) Filed: Sep. 16, 2015

(30) Foreign Application Priority Data
Sep. 30, 2014 (JP) 2014-201552

(51) Int. Cl. G01P 15/125

(52) U.S. Cl. CPC G01P 15/125

(57) ABSTRACT

An acceleration sensor that achieves a simultaneous operation method of a signal detection and a servo control is provided as an alternative to a time-division processing method. The acceleration sensor is a MEMS capacitive acceleration sensor. The acceleration sensor includes signal detection capacitor pairs 12, 15, and DC servo control capacitor pairs 13, 16, and AC servo control capacitor pairs 14, 17, which are different from the signal detection capacitor pairs 12, 15. A voltage that generates a force in a direction opposite to a detection signal of acceleration detected by the signal detection capacitor pairs 12, 15 is applied to the DC servo control capacitor pairs 13, 16 and the AC servo control capacitor pairs 14, 17.

### CROSS-REFERENCE TO RELATED APPLICATION

The present application claims priority from Japanese Patent Application No. 2014-201552 filed on Sep. 30, 2014, the content of which is hereby incorporated by reference into this application.

### TECHNICAL FIELD OF THE INVENTION

The present invention relates to an acceleration sensor, and more particularly, relates to Micro Electro Mechanical Systems (MEMS) capacitive acceleration sensor.

### BACKGROUND OF THE INVENTION

A MEMS capacitive acceleration sensor has a configuration that reduces an area by sharing MEMS capacitive elements for the purpose of a signal detection and for the purpose of a servo force application (that is, for the purpose of servo control) that generates a force in an opposite direction of a detection signal. In this configuration, in order to share the MEMS capacitive elements, a method of alternately performing the signal detection and the servo control is used in time-division processing. In addition, in the time-division processing, a method of interposing a reset between the signal detection and the servo control is used. Such time-division processing method is disclosed in, for example, U.S. Pat. No. 5,852,242 (Patent Document 1) and U.S. Pat. No. 6,497,149 (Patent Document 2).

### SUMMARY OF THE INVENTION

The time-division processing method disclosed in the above-mentioned Patent Document 1 and Patent Document 2 has the following problems.

(1) In the case of performing the time-division processing, if intending to maintain a signal processing band, an internal operating speed increases twofold (a method of alternately performing the signal detection and the servo control) or fourfold (a method of interposing the reset between the signal detection and the servo control). Therefore, the power consumption of an analog circuit, such as an amplifier, a filter, an A/D converter, or the like, a logic circuit, and a servo control unit (D/A converter) increases twofold or fourfold.

(2) In the case of performing a time-division switching, a sampling noise (kT/C noise, where k is a Boltzmann's constant) is generated by a switching operation for switching, and a noise density increases. This is an inevitable fundamental phenomenon. This leads to an increase in a noise of a sensor.

(3) In the case of performing the time-division processing, in order to ensure an effective servo force, it is necessary to increase a servo voltage or a MEMS capacitance value for servo. In the case of the former, a design of a high-voltage low-noise circuit is difficult or originally impossible due to a breakdown voltage of a MOS transistor of a semiconductor process. In the case of the latter, a merit that achieves an area reduction by sharing the MEMS capacitance for the detection and the servo by the time-division processing is lost.

A typical object of the present invention is to solve the above-described problems of the time-division processing method and provide an acceleration sensor, as an alternative to the time-division processing method, which achieves a simultaneous operation method of a signal detection and a servo control.

The above and other object and novel characteristics of the present invention will be apparent from the description of the present specification and the accompanying drawings.

The typical ones of the inventions disclosed in the present application will be briefly described as follows.

### SUMMARY OF THE INVENTION

A typical acceleration sensor is a MEMS capacitive acceleration sensor. The acceleration sensor includes a first capacitor pair for signal detection and a second capacitor pair for servo control, which is different from the first capacitor pair. A voltage that generates a force in a direction opposite to a detection signal of acceleration by the first capacitor pair is applied to the second capacitor pair.

The effects obtained by typical aspects of the invention disclosed in the present application will be briefly described below.

As a typical effect, an acceleration sensor which achieves a simultaneous operation method of a signal detection and a servo control as an alternative to the time-division processing method can be provided.

### BRIEF DESCRIPTIONS OF THE DRAWINGS

FIG. 1 is a diagram illustrating an example of a configuration of an acceleration sensor according to a first embodiment of the present invention;

FIG. 2 is a diagram illustrating an example of a configuration of an acceleration sensor according to a second embodiment of the present invention;

FIG. 3 is a diagram illustrating an example of a configuration of an acceleration sensor according to a third embodiment of the present invention;

FIG. 4 is a diagram illustrating an example of a configuration of an acceleration sensor according to a fourth embodiment of the present invention;

FIG. 5 is a diagram illustrating an example of a configuration of an acceleration sensor according to a fifth embodiment of the present invention;

FIG. 6 is a diagram illustrating an example of a configuration of an acceleration sensor according to a sixth embodiment of the present invention; and

FIG. 7 is a diagram illustrating an example of a configuration of an acceleration sensor according to a seventh embodiment of the present invention.

### DESCRIPTIONS OF THE PREFERRED EMBODIMENTS

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof. Also, in the embodiments described below, when referring to the number of elements (including number of pieces, values, amount, range, and the like), the number of the elements is not limited to a specific number unless otherwise stated or except the case where the number is apparently limited to a specific number in principle. The number larger or smaller than the specified number is also applicable.

Further, in the embodiments described below, it goes without saying that the components (including element steps) are not always indispensable unless otherwise stated or except the case where the components are apparently indispensable in principle. Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

### Overview of Embodiments

First, the overview of embodiments will be described. In the overview of the present embodiment, as an example, corresponding elements, reference numerals, and the like of the embodiments in parentheses will be described.

A typical acceleration sensor according to an embodiment is a MEMS capacitive acceleration sensor. The acceleration sensor includes: a first capacitor pair for signal detection (signal detection capacitor pairs 12, 15, 62, 66, and 92); and a second capacitor pair for servo control (DC servo control capacitor pairs 13, 16, 63, 67, and 93 and AC servo control capacitor pairs 14, 17, 64, 65, 68, 69, and 94), which is different from the first capacitor pair. A voltage that generates a force in a direction opposite to a detection signal of acceleration by the first capacitor pair is applied to the second capacitor pair.

More preferably, in the acceleration sensor, the voltage that generates the force in a direction opposite to the detection signal of acceleration by the first capacitor pair is applied to the second capacitor pair during the detection of the detection signal. As the second capacitor pair, the acceleration sensor includes, a third capacitor pair for DC component servo control (DC servo control capacitor pairs 13, 16, 63, 67, and 93) and a fourth capacitor pair for AC component servo control (AC servo control capacitor pairs 14, 17, 64, 65, 68, 69, and 94). As the first capacitor pair, the acceleration sensor includes a fifth capacitor pair for positive-side signal detection (signal detection capacitor pairs 12 and 62) and a sixth capacitor pair for negative-side signal detection (signal detection capacitor pairs 15 and 66). As the second capacitor pair, the acceleration sensor includes a seventh capacitor pair for DC component servo control (DC servo control capacitor pairs 63 and 67) and a plurality of eighth capacitor pairs for AC component servo control (AC servo control capacitor pairs 64, 65, 68, and 69).

Furthermore, more preferably, the acceleration sensor includes a first servo control circuit (DC servo control unit 28, AC servo control unit 30, and the like) that applies the voltage, which generates the force in a direction opposite to the detection signal of acceleration by the first capacitor pair, to the second capacitor pair. The acceleration sensor includes a second servo control circuit (DC servo control unit 28) that applies a first voltage to the third capacitor pair, and a third servo control circuit (AC servo control unit 30, and the like) that applies a second voltage which is different from the first voltage to the fourth capacitor pair. The acceleration sensor includes a differential detection circuit (charge amplifiers 23 and 24) that receives a positive-side detection signal by the fifth capacitor pair and a negative-side detection signal by the sixth capacitor pair as an input, and performs a differential detection. The acceleration sensor includes a fully differential detection circuit (charge amplifier 51) that receives the positive-side detection signal by the fifth capacitor pair and the negative-side detection signal by the sixth capacitor pair as an input, and performs a fully differential detection. The acceleration sensor includes a fourth servo control circuit (DC servo control unit 28) that applies a third voltage to the seventh capacitor pair, and a fifth servo control circuit (AC servo control unit 30, multi-valued quantizer 70, and multi-valued D/A converter 71) that applies each fourth voltage by the multi-valued quantization, which is different from the third voltage, to the plurality of eighth capacitor pairs.

Hereinafter, each embodiment based on the overview of the above-described embodiment will be described in detail with reference to the drawings. Note that the same components are denoted by the same or related reference symbols throughout all the drawings for describing the embodiment, and the repetitive description thereof will be omitted. Also, in the following embodiments, the description of the same or similar parts is not repeated in principle unless particularly required.

### First Embodiment

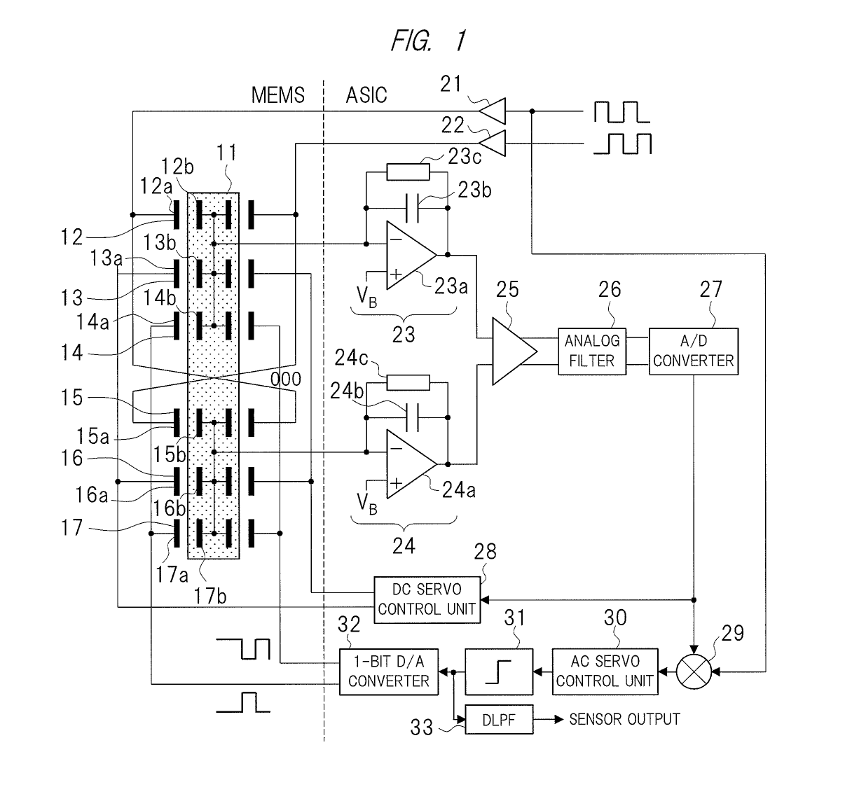

An acceleration sensor according to a first embodiment will be described with reference to FIG. 1. FIG. 1 is a diagram illustrating an example of a configuration of an acceleration sensor. The acceleration sensor according to the first embodiment is an example of a servo configuration by “differential MEMS & common weight between differentials & differential amplifier”.

In the acceleration sensor, a mechanical part is configured by a Micro Electro Mechanical Systems (MEMS), and a circuit part is configured by an Application Specific Integrated Circuit (ASIC). The acceleration sensor is not limited to this. However, for example, as a sensor for reflection seismic survey that explores oil, natural gas, or the like, this acceleration sensor is used in a MEMS capacitive acceleration sensor that detects an oscillation acceleration, which is extremely smaller than gravity.

<MEMS>

In the MEMS, a positive-side acceleration detection element and a negative-side acceleration detection element are formed in one element. Both the positive-side acceleration detection element and the negative-side acceleration detection element operate for the same acceleration signal (in a direction and an amount) applied from the outside (that is, for inertia force). However, phase driving voltages which are opposite to each other are applied to signal detection capacitor units of these elements, and therefore, electrical signals having the mutually opposite signs and the same amount are generated from these elements. Thus, signal processing such as amplification is performed by a differential circuit that treats a difference between these electrical signals as a signal. Such a “differential MEMS” configuration has three major advantages. First, since a signal amount increases twofold with respect to the same acceleration signal, twofold of circuit noise can be allowed, that is, the power consumption of the circuit can be reduced to ¼ in theory. Second, since there is no influence of a common mode noise of the circuit (such as power noise of a charge amplifier or the like), noise can be reduced. Third, since there is no influence of a movable electrode displacement of the AC servo control capacitor unit or the DC servo control capacitor unit, noise can be reduced. As described later, this is because the AC servo voltage or the DC servo voltage is applied in the same phase to the differential MEMS configuration.

The positive-side acceleration detection element and the negative-side acceleration detection element include the signal detection capacitor pairs 12 and 15, the DC servo control capacitor pairs 13 and 16, and the AC servo control capacitor pairs 14 and 17, respectively, which are common with each other in the weight 11 between the differentials. Each of the signal detection capacitor pairs 12 and 15, the DC servo control capacitor pairs 13 and 16, and the AC servo control capacitor pairs 14 and 17 is configured by electrodes of a capacitive capacitor pair. Each pair structure of these capacitor pairs is a structure for various known purposes such as cancellation of a common mode component of the capacitance value although not described in detail.

Each of the signal detection capacitor pairs 12 and 15 is a capacitor pair for detecting the application of the acceleration. Each of the DC servo control capacitor pairs 13 and 16 is a capacitor pair for servo voltage application of a DC component (direct-current component=gravity component) that generates a force in a direction opposite to the detection signal by the signal detection capacitor pairs 12 and 15, that is, is a capacitor pair for DC servo control. Each of the AC servo control capacitor pairs 14 and 17 is a capacitor pair for servo voltage application of an AC component (alternate-current component=oscillation component) that generates a force in a direction opposite to the detection signal by the signal detection capacitor pairs 12 and 15, that is, is a capacitor pair for AC servo control.

In the positive-side acceleration detection element, the signal detection capacitor pair 12 is provided with two pairs each including a fixed electrode 12a fixed to a frame body of the MEMS and a movable electrode 12b which is movable in accordance with a variable capacitance between the movable electrode 12b and the fixed electrode 12a. Similarly, the DC servo control capacitor pair 13 is provided with two pairs each including a fixed electrode 13a and a movable electrode 13b. Similarly, the AC servo control capacitor pair 14 is provided with two pairs each including a fixed electrode 14a and a movable electrode 14b.

The negative-side acceleration detection element also has the same configuration as the positive-side acceleration detection element in the signal detection capacitor pair 15 (a fixed electrode 15a and a movable electrode 15b), the DC servo control capacitor pair 16 (a fixed electrode 16a and a movable electrode 16b), and the AC servo control capacitor pair 17 (a fixed electrode 17a and a movable electrode 17b).

The parts of the movable electrodes 12b, 13b, 14b, 15b, 16b, and 17b of the positive-side acceleration detection element and the negative-side acceleration detection element are mechanically and commonly configured to be one part as the weight 11. The weight 11 is an oscillator that detects the acceleration. For example, when the weight 11 is displaced in the right direction in FIG. 1 by the application of the acceleration, a distance between the movable electrodes 12b and 15b and the fixed electrodes 12a and 15a on the right side of the signal detection capacitor pairs 12 and 15 becomes narrow so as to provide a capacitance change value of +ΔC, and a distance between the movable electrodes 12b and 15b and the fixed electrodes 12a and 15a on the left side of the signal detection capacitor pairs 12 and 15 becomes wide so as to provide a capacitance change value of −ΔC. The oscillation in the direction of the positive side or the direction of the negative direction caused by the application of the acceleration can be detected based on such capacitance change values (+ΔC and −ΔC) in these signal detection capacitor pairs 12 and 15. For convenience of description, note that that the MEMS configuration in the above description and FIG. 1 is a parallel plate capacitor. However, a similar mechanism is also established in other types of capacitors. Therefore, the present invention is not limited to the parallel-plate capacitor type MEMS.

In the positive-side acceleration detection element, the movable electrode 12b of the signal detection capacitor pair 12, the movable electrode 13b of the DC servo control capacitor pair 13, and the movable electrode 14b of the AC servo control capacitor pair 14 are electrically connected to one another. The commonly-connected movable electrodes 12b, 13b, and 14b of the positive-side acceleration detection element are electrically connected to the charge amplifier 23 of the ASIC.

Also in the negative-side acceleration detection element, the movable electrode 15b of the signal detection capacitor pair 15, the movable electrode 16b of the DC servo control capacitor pair 16, and the movable electrode 17b of the AC servo control capacitor pair 17 are electrically connected to one another. The commonly-connected movable electrodes 15b, 16b, and 17b of the negative-side acceleration detection element are electrically connected to the charge amplifier 24 of the ASIC.

In the positive-side acceleration detection element, the fixed electrode 12a of the signal detection capacitor pair 12 is electrically connected to drivers 21 and 22, the fixed electrode 13a of the DC servo control capacitor pair 13 is electrically connected to a DC servo control unit 28, and the fixed electrode 14a of the AC servo control capacitor pair 14 is electrically connected to a 1-bit D/A converter 32.

In the negative-side acceleration detection element, the fixed electrode 15a of the signal detection capacitor pair 15 is electrically connected to the drivers 21 and 22, the fixed electrode 16a of the DC servo control capacitor pair 16 is electrically connected t is electrically connected to the DC servo control unit 28, and the fixed electrode 17a of the AC servo control capacitor pair 17 is electrically connected to the 1-bit D/A converter 32.

The driver 21 and the driver 22 are connected to cross each other between the fixed electrode 12a of the signal detection capacitor pair 12 of the positive-side acceleration detection element and the fixed electrode 15a of the signal detection capacitor pair 15 of the negative-side acceleration detection element. That is, the fixed electrode 12a on the left side in FIG. 1 in the signal detection capacitor pair 12 of the positive-side acceleration detection element and the fixed electrode 15a on the right side in FIG. 1 in the signal detection capacitor pair 15 of the negative-side acceleration detection element are connected to the driver 21. On the other hand, the fixed electrode 12a on the right side in FIG. 1 in the signal detection capacitor pair 12 of the positive-side acceleration detection element and the fixed electrode 15a on the left side in FIG. 1 in the signal detection capacitor pair 15 of the negative-side acceleration detection element are connected to the driver 22. As described above, this is done for performing the detection by the differential circuit by applying opposite-phase voltages to the positive-side acceleration detection element and the negative acceleration detection element.

<ASIC>

The ASIC includes drivers 21 and 22, charge amplifiers 23 and 24, an amplifier 25, an analog filter 26, an A/D converter 27, a DC servo control unit 28, a demodulator 29, an AC servo control unit 30, a 1-bit quantizer 31, and a 1-bit D/A converter 32.

The drivers 21 and 22 are circuits that receive a non-inverted modulation clock and an inverted modulation clock having opposite phases as an input, respectively, and apply driving voltages to the fixed electrodes 12a and 15a of the signal detection capacitor pairs 12 and 15. One driver 21 has an output connected to the fixed electrode 12a on the left side in FIG. 1 in the signal detection capacitor pair 12 in FIG. 1 and the fixed electrode 15a on the right side in FIG. 1 in the signal detection capacitor pair 15, and applies driving voltages to the fixed electrode 12a and the fixed electrode 15a. The other driver 22 has an output connected to the fixed electrode 12a on the right side in FIG. 1 in the signal detection capacitor pair 12 and the fixed electrode 15a on the left side in FIG. 1 in the signal detection capacitor pair 15, and applies driving voltages to the fixed electrode 12a and the fixed electrode 15a.

The charge amplifiers 23 and 24 are C/V conversion circuits that include operational amplifiers 23a and 24a, and feedback capacitors 23b and 24b and high-resistance resistors 23c and 24c, which are connected in parallel between inputs and outputs of the operational amplifiers 23a and 24a, respectively. One charge amplifier 23 is a C/V conversion circuit for the positive-side acceleration detection element, and has an input connected to the movable electrodes 12b, 13b, and 14b, and an output connected to the amplifier 25. The operational amplifier 23a has an inverting input (−) to which signals from the movable electrodes 12b, 13b, and 14b are input, and a non-inverting input (+) to which a reference voltage V_{B} is applied. The charge amplifier 23 converts the capacitance change value between the fixed electrode 12a and the movable electrode 12b, which is proportional to the displacement of the weight 11 by the application of the acceleration, into a voltage, and outputs the voltage to the amplifier 25. Here, the reason why the high-resistance resistors 23c and 24c are inserted into the feedback parts in parallel is to ensure a direct-current feed path that compensates for input leakage currents of the operational amplifiers 23a and 24a. Meanwhile, such a countermeasure as using a reset switch in the parts of the high-resistance resistors 23c and 24c has been conventionally known. However, this case has a problem of a high noise density of sampling noises due to the reset switch. Note that thermal noises caused by the high-resistance resistors 23c and 24c used in the present method have no problem because the thermal noises are sufficiently suppressed in periphery of a desired frequency (that is, a frequency of a modulation clock) by low-pass filter characteristics based on the high-resistance resistors 23c and 24c and the feedback capacitors 23b and 24b.

The other charge amplifier 24 is a C/V conversion circuit for the negative-side acceleration detection element, and has an input connected to the movable electrodes 15b, 16b, and 17b, and has an output connected to the amplifier 25. The operational amplifier 24a has an inverting input (−) to which signals from the movable electrodes 15b, 16b, and 17b are input, and a non-inverting input (+) to which the reference voltage V_{B} is applied. The charge amplifier 24 converts the capacitance change value between the fixed electrode 15a and the movable electrode 15b, which is proportional to the displacement of the weight 11 caused by the application of the acceleration, into a voltage, and outputs the voltage to the amplifier 25.

The amplifier 25 has an input connected to the charge amplifiers 23 and 24 and an output connected to the analog filter 26. The amplifier 25 is a circuit that receives the voltage converted in the charge amplifier 23 and the voltage converted in the charge amplifier 24 as inputs, performs differential amplification based on these voltages, and outputs the differentially-amplified voltage to the analog filter 26.

The analog filter 26 has an input connected to the amplifier 25 and an output connected to the A/D converter 27. The analog filter 26 is a circuit that receives the voltage differentially amplified by the amplifier 25 as an input, removes a noise component included in the voltage, and outputs the noise-removed voltage to the A/D converter 27.

The A/D converter 27 has an input connected to the analog filter 26 and an output connected to the DC servo control unit 28 and the demodulator 29. The A/D converter 27 is a circuit that receives the analog voltage, from which the noise is removed by the analog filter 26, as an input, converts the analog voltage into a digital value, and outputs the digital value to the DC servo control unit 28 and the demodulator 29.

The DC servo control unit 28 has an input connected to the A/D converter 27 and an output connected to the fixed electrodes 13a and 16a of the DC servo control capacitor pairs 13 and 16. The DC servo control unit 28 is a circuit that receives the digital value converted by the A/D converter 27 as an input, determines a servo voltage (DC component) that generates a force in a direction opposite to the detection signal, based on the digital value, and applies the servo voltage to the fixed electrodes 13a and 16a of the DC servo control capacitor pairs 13 and 16. In the DC servo control unit 28, one output is applied to the fixed electrodes 13a and 16a on the right side in FIG. 1, and the other output is applied to the fixed electrodes 13a and 16a on the left side in FIG. 1.

The demodulator 29 has two inputs connected to the A/D converter 27 and the input of the driver 21 and has an output connected to the AC servo control unit 30. The demodulator 29 is a circuit that receives the digital value converted by the A/D converter 27 and the modulation clock input to the driver 21 as an input, that multiplies this digital value and the modulation clock, to demodulate the multiplied value into the capacitance change value proportional to the displacement of the weight 11 by the application of the acceleration, and that outputs the demodulated capacitance change value to the AC servo control unit 30. A series of such modulation and demodulation processing is equivalent to a so-called “chopper system” and can avoid the influence of 1/f noise generated in the charge amplifiers 23 and 24, the amplifier 25, the analog filter 26, and the A/D converter 27.

The AC servo control unit 30 has an input connected to the demodulator 29 and has an output connected to the 1-bit quantizer 31. The AC servo control unit 30 is a circuit that receives the capacitance change value demodulated by the demodulator 29 as an input, that determines a servo value (AC component) that generates a force in a direction opposite to the detection signal based on the capacitance change value, and that outputs the determined servo value to the 1-bit quantizer 31.

The 1-bit quantizer 31 has an input connected to the AC servo control unit 30 and an output connected to the 1-bit D/A converter 32. The 1-bit quantizer 31 is a circuit that receives the servo value (AC component) determined by the AC servo control unit 30 as an input, that quantizes the servo value into 1 bit, and that outputs the 1 bit value to the D/A converter 32. Note that the output of the 1-bit quantizer 31 is also inputted to a digital low-pass filter (DLPF) 33, a high-frequency component (that is, quantization error noise-shaped (diffused) onto a high-frequency side by a sigma-delta control of a servo loop) is suppressed by the DLPF 33, and the output of the DLPF 33 becomes a final output as the acceleration sensor.

The 1-bit D/A converter 32 has an input connected to the 1-bit quantizer 31 and has an output connected to the fixed electrodes 14a and 17a of the AC servo control capacitor pairs 14 and 17. The 1-bit D/A converter 32 is a circuit that receives the 1-bit digital value quantized by the 1-bit quantizer 31 as an input, that converts the digital value into an analog voltage (for example, ±5 V or 0 V/10 V), and that applies the analog voltage to the fixed electrodes 14a and 17a of the AC servo control capacitor pairs 14 and 17. In the 1-bit D/A converter 32, one (non-inverted) output is applied to the fixed electrodes 14a and 17a on the right side in FIG. 1, and the other (inverted) output is applied to the fixed electrodes 14a and 17a on the left side in FIG. 1. By inserting the 1-bit quantizer 31 as described above, the subsequent D/A converter can be the 1-bit D/A converter 32. Since the 1-bit D/A converter is easy to be mounted in terms of circuit, it is advantageous to low power consumption. Furthermore, the AC servo control capacitor unit can be also simplified as described above.

<Simultaneous Operation Method of Signal Detection and Servo Control>

In the acceleration sensor having the above-described configuration, the simultaneous operation method of the signal detection and the servo control is achieved.

The signal detection is operated as follows. At the time of the signal detection, the drivers 21 and 22 receive the non-inverted modulation clock and the inverted modulation clock having opposite phases from each other as inputs, respectively, and that apply the driving voltages to the fixed electrodes 12a and 15a of the signal detection capacitor pairs 12 and 15. At this time, the DC servo control unit 28 applies the servo voltage (DC component), which generates the force in a direction opposite to the detection signal, to the fixed electrodes 13a and 16a of the DC servo control capacitor pairs 13 and 16. In addition, the 1-bit D/A converter 32 applies the analog voltage, which corresponds to the servo voltage (AC component) that generates the force in a direction opposite to the detection signal, to the fixed electrodes 14a and 17a of the AC servo control capacitor pairs 14 and 17.

In this state, the charge amplifiers 23 and 24 convert the capacitance change value (for example, +ΔC) between the fixed electrode 12a and the movable electrode 12b and the capacitance change value (for example, −ΔC) between the fixed electrode 15a and the movable electrode 15b, the capacitance change values being proportional to the displacement of the weight 11 generated by the application of the acceleration, into voltages, and output the voltages to the amplifier 25. Then, the amplifier 25 receives the voltage converted by the charge amplifier 23 and the voltage converted by the charge amplifier 24 as inputs, differentially amplifies the inputs based on these voltages, and outputs the differentially-amplified voltage to the analog filter 26. Furthermore, the analog filter 26 receives the voltage differentially amplified by the amplifier 25b as an input, that removes a noise component included in the voltage, and that outputs the noise-removed voltage to the A/D converter 27. Then, the A/D converter 27 receives the analog voltage, from which the noise is removed by the analog filter 26, as an input, converts the analog voltage into a digital value, and outputs the digital value to the DC servo control unit 28 and the demodulator 29. The above-described processing is the operation of the signal detection.

The servo control is operated as follows. Also at the time of the servo control, the drivers 21 and 22 receive the non-inverted modulation clock and the inverted modulation clock having opposite phases from each other as inputs, respectively, and apply the driving voltages to the fixed electrodes 12a and 15a of the signal detection capacitor pairs 12 and 15. Then, the DC servo control unit 28 receives a digital value converted by the A/D converter 27 as an input, determines a servo voltage (DC component) that generates a force in a direction opposite to a detection signal, based on the digital value, and applies the servo voltage to the fixed electrodes 13a and 16a of the DC servo control capacitor pairs 13 and 16. The DC servo control unit 28 includes, for example, a demodulator similar to the demodulator 29, a narrow-band digital low-pass filter that extracts only DC component of an input acceleration, a control signal processing unit, a multi-bit (multi-valued) D/A converter that supplies a servo voltage (DC component) by converting a digital output value of the control signal processing unit into an analog voltage, and others. Since the D/A converter may be operated in a low speed for DC control although being a multi-bit converter, the power consumption and the noise are not increased. Note that the main purpose of the DC servo is to cancel gravity acceleration generated when a sensor module is disposed in a vertical direction (when being inclined from the vertical direction, a component of the gravity acceleration in a direction of a sensor sensitivity axis). Since this component is static, the operation of determining the servo voltage (DC component) by the DC servo control unit 28 may be only required to be performed, for example, only once before a period in which the AC acceleration signal has not been inputted yet, and to continuously apply the previously-determined servo voltage (DC component) to the fixed electrodes 13a and 16a of the DC servo control capacitor pairs 13 and 16 at the time of the AC acceleration signal detection operation.

In parallel, the demodulator 29 receives the digital value converted by the A/D converter 27 and the modulation clock inputted to the driver 21 as inputs, multiplies the digital value and the modulation clock to demodulate the multiplied value into the capacitance change value proportional to the displacement of the weight 11 generated by the application of the acceleration, and outputs the demodulated capacitance change value to the AC servo control unit 30. Then, the AC servo control unit 30 receives the capacitance change value demodulated by the demodulator 29 as an input, determines a servo value (AC component) that generates a force in a direction opposite to the detection signal, based on the capacitance change value, and outputs the determined servo value to the 1-bit quantizer 31. Furthermore, the 1-bit quantizer 31 receives the servo value (AC component) determined by the AC servo control unit 30 as an input, quantizes the servo value into 1 bit, and outputs the 1 bit value to the D/A converter 32. Then, the 1-bit D/A converter 32 receives the 1-bit digital value quantized by the 1-bit quantizer 31 as an input, converts the digital value into an analog voltage, and applies the analog voltage to the fixed electrodes 14a and 17a of the AC servo control capacitor pairs 14 and 17. Here, as shown by a wire connection of FIG. 1, both the servo voltage (DC component) and the servo voltage (AC component) are applied in the same phase to the differential MEMS configuration. Therefore, the electrical signals, which are generated by the displacement of the movable electrode unit (that is, the weight) of the DC servo control capacitor pairs 13 and 16 or the AC servo control capacitor pairs 14 and 17, are the same in the differentials and thus are cancelled as the differential signals. The above-described processing is the operation of the servo control.

As described above, the voltage that generates the force in a direction opposite to the detection signal of acceleration detected by the signal detection capacitor pairs 12 and 15 is applied to the DC servo control capacitor pairs 13 and 16 and the AC servo control capacitor pairs 14 and 17 during the detection of the detection signal. Therefore, the present embodiment can achieve the simultaneous operation method of the signal detection and the servo control. Furthermore, since a different voltage can be applied to the DC servo control capacitor pairs 13 and 16 and the AC servo control capacitor pairs 14 and 17, the servo voltage (DC component) and the servo voltage (AC component) can be individually controlled. In this manner, since the MEMS capacitive elements dedicated to the DC servo are provided so as to be independent from each other, an absolute value of a dynamically required servo force can be reduced (that is, it is only necessary to handle the alternate-current (oscillated) acceleration applied from the outside), and therefore, the output voltage of the 1-bit D/A converter 32 for the AC servo or the capacitance value of the AC servo control capacitor pairs 14 and 17 can be reduced. As a result, the power consumption consumed for the charge and discharge of the AC servo control capacitor pairs 14 and 17 can be reduced. Note that the DC servo control is static, and therefore, steady charge and discharge of the DC servo control capacitor pairs 13 and 16 are not performed.

### Effect of First Embodiment

As descried above, in the acceleration sensor according to the first embodiment, the simultaneous operation method of the signal detection and the servo control can be achieved. That is, as an alternative to the time-division processing method, the simultaneous operation method of the signal detection and the servo control can be achieved. As a result, since it is unnecessary to maintain the signal processing band as in the time-division processing, the internal operating speed and the power consumption are not increased. In addition, since it is unnecessary to perform the time-division switching as in the time-division processing, sampling noise is not generated and the noise of the sensor is not increased. In addition, since it is unnecessary to raise the servo voltage or increase the MEMS capacitance value for the servo as in the time-division processing, it is easy to design the high-voltage low-noise circuit, and the merit of the area reduction is not lost.

In addition, in the acceleration sensor according to the first embodiment, since the weight 11 is identical and common between the differential MEMS of the positive-side acceleration detection element and the differential MEMS of the negative-side acceleration detection element, the capacitance change value ΔC between the differentials is well matched and high-accuracy detection is possible.

### Second Embodiment

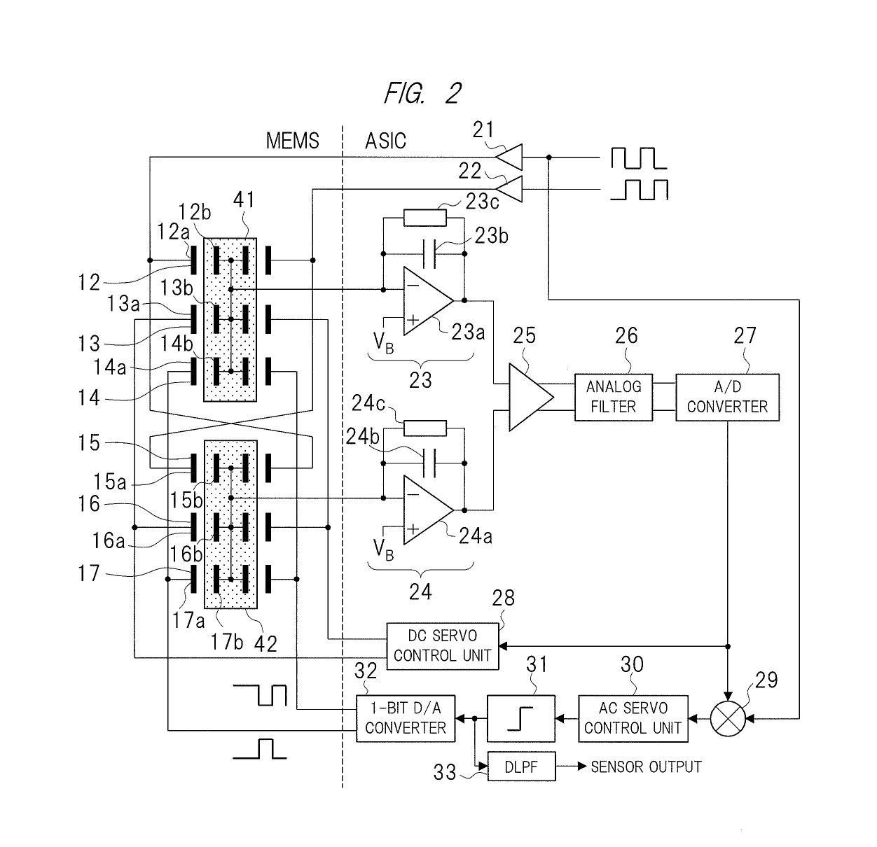

An acceleration sensor according to a second embodiment will be described with reference to FIG. 2. FIG. 2 is a diagram illustrating an example of a configuration of an acceleration sensor. The acceleration sensor according to the second embodiment is an example of a servo configuration based on “differential MEMS & different weights between differentials & differential amplifier”. The second embodiment is different from the first embodiment in that the weight between the differentials is different between the positive-side acceleration detection element and the negative-side acceleration detection element of the MEMS. In the second embodiment, a difference from the first embodiment will be mainly described.

In the MEMS, weights 41 and 42 are different in the positive-side acceleration detection element and the negative-side acceleration detection element. The positive-side acceleration detection element has one weight 41, and the negative-side acceleration detection element has the other weight 42.

The positive-side acceleration detection element includes the weight 41, a signal detection capacitor pair 12, a DC servo control capacitor pair 13, and an AC servo control capacitor pair 14. The negative-side acceleration detection element includes the weight 42, a signal detection capacitor pair 15, a DC servo control capacitor pair 16, and an AC servo control capacitor pair 17.

In the above-described acceleration sensor according to the second embodiment, the simultaneous operation method of the signal detection and the servo control can be achieved as similar to the first embodiment. As a result, as an alternative to the time-division processing method, the simultaneous operation method of the signal detection and the servo control can be achieved, and therefore, the same effect as those of the first embodiment can be obtained. However, in the acceleration sensor according to the second embodiment, since the weight 41 of the positive-side acceleration detection element and the weight 42 of the negative-side acceleration detection element are different from each other, it is necessary to spatially arrange the respective elements so that the capacitance change value ΔC between the differentials is matched. Instead, even if a part of the movable electrode of the capacitor pair (triple-layer structure formed of a frame body fixing part, an insulation part, and an electrode part) is not a silicon on insulator (SOI), the MEMS can be achieved.

### Third Embodiment

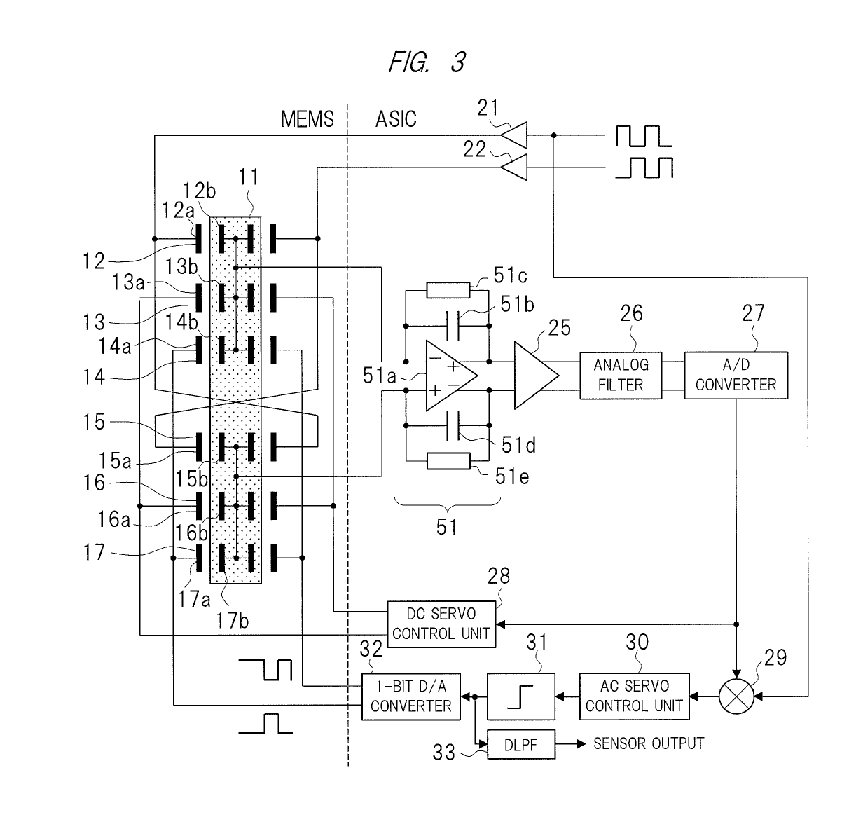

An acceleration sensor according to a third embodiment will be described with reference to FIG. 3. FIG. 3 is a diagram illustrating an example of a configuration of an acceleration sensor. The acceleration sensor according to the third embodiment will be described in an example of a servo configuration formed by “differential MEMS & common weight between differentials & fully differential amplifier”. The third embodiment is different from the first and second embodiments in that a charge amplifier of an ASIC is changed from a single-ended output operational amplifier to a fully differential operational amplifier. In the third embodiment, a difference from the first and second embodiments will be mainly described.

In the ASIC, a charge amplifier 51 is a C/V conversion circuit based on a fully differential detection, which includes a fully differential operational amplifier 51a, a feedback capacitor 51b and a high-resistance resistor 51c connected in parallel between an inverted input (−) and a non-inverted output (+) of the fully differential operational amplifier 51a, and a feedback capacitor 51d and a high-resistance resistor 51e connected in parallel between a non-inverted input (+) and an inverted output (−) of the fully differential operational amplifier 51a. A reason why the high-resistance resistors 51c and 51e are used is as described above.

In the charge amplifier 51, the inverted input (−) of the fully differential operational amplifier 51a is connected to movable electrodes 12b, 13b, and 14b of a positive-side acceleration detection element, and the non-inverted output (+) of the fully differential operational amplifier 51a is connected to one input of an amplifier 25. In the fully differential operational amplifier 51a, signals from the movable electrodes 12b, 13b, and 14b are inputted to one inverted input (−) of the fully differential operational amplifier 51a, a capacitance change value between a fixed electrode 12a and the movable electrode 12b, which is proportional to the displacement of the weight 11 displaced by the application of the acceleration, is converted into a voltage, and the voltage is outputted to one input of the amplifier 25. In addition, in the fully differential operational amplifier 51a, signals from movable electrodes 15b, 16b, and 17b are inputted to the other non-inverted input (+), a capacitance change value between a fixed electrode 15a and the movable electrode 15b, which is proportional to the displacement of the weight 11 displaced by the application of the acceleration, is converted into a voltage, and the voltage is outputted to the other input of the amplifier 25.

Then, the amplifier 25 differentially amplifies a differential output voltage of the fully differential operational amplifier 51a, and outputs the amplified differential output voltage to an analog filter 26. The subsequent operations are the same as those of the first embodiment.

Also in the above-described acceleration sensor according to the third embodiment, the simultaneous operation method of the signal detection and the servo control can be achieved as similar to the first embodiment. As a result, as an alternative to the time-division processing method, the simultaneous operation method of the signal detection and the servo control can be achieved, and therefore, the same effects as those of the first embodiment can be obtained. Furthermore, in the acceleration sensor according to the third embodiment, since only one fully differential operational amplifier 51a which achieves the fully differential detection is used as the charge amplifier 51, the acceleration sensor is more advantageous in terms of power consumption than the systems (23a, 24a) that use two operational amplifiers as described in the first and second embodiments. However, since noise is mixed to a servo force by a common mode noise of the fully differential operational amplifier 51a, it is required to design low noise of a common mode noise component.

### Fourth Embodiment

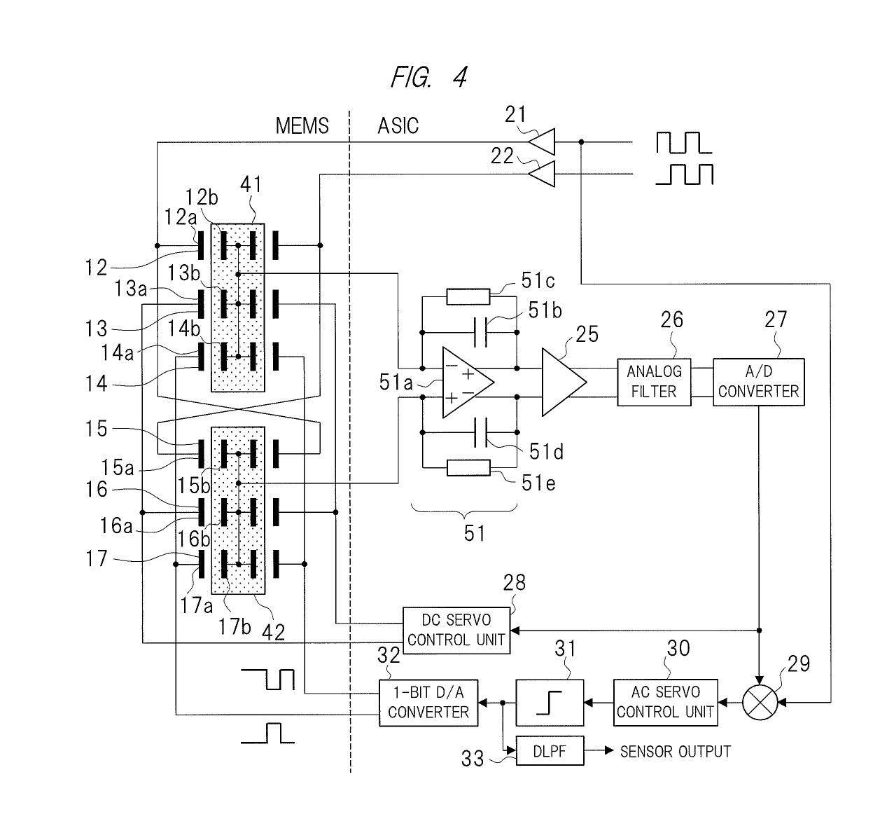

An acceleration sensor according to a fourth embodiment will be described with reference to FIG. 4. FIG. 4 is a diagram illustrating an example of a configuration of an acceleration sensor. The acceleration sensor according to the fourth embodiment will be described in an example of a servo configuration formed by “differential MEMS & different weight between differentials & fully differential amplifier”. The fourth embodiment is an example in which the weight between differentials is different between the positive-side acceleration detection element and the negative-side acceleration detection element of the MEMS as similar to the second embodiment, and in which the charge amplifier of the ASIC is changed from the operational amplifier to the fully differential operational amplifier as similar to the third embodiment. More details are as described in the second and third embodiments.

Also in the above-described acceleration sensor according to the fourth embodiment, the simultaneous operation method of the signal detection and the servo control can be achieved as similar to the first embodiment. As a result, as an alternative to the time-division processing method, the simultaneous operation method of the signal detection and the servo control can be achieved, and therefore, the same effects as those of the first embodiment, more particularly, the same effects as those of the second and third embodiments, can be obtained.

### Fifth Embodiment

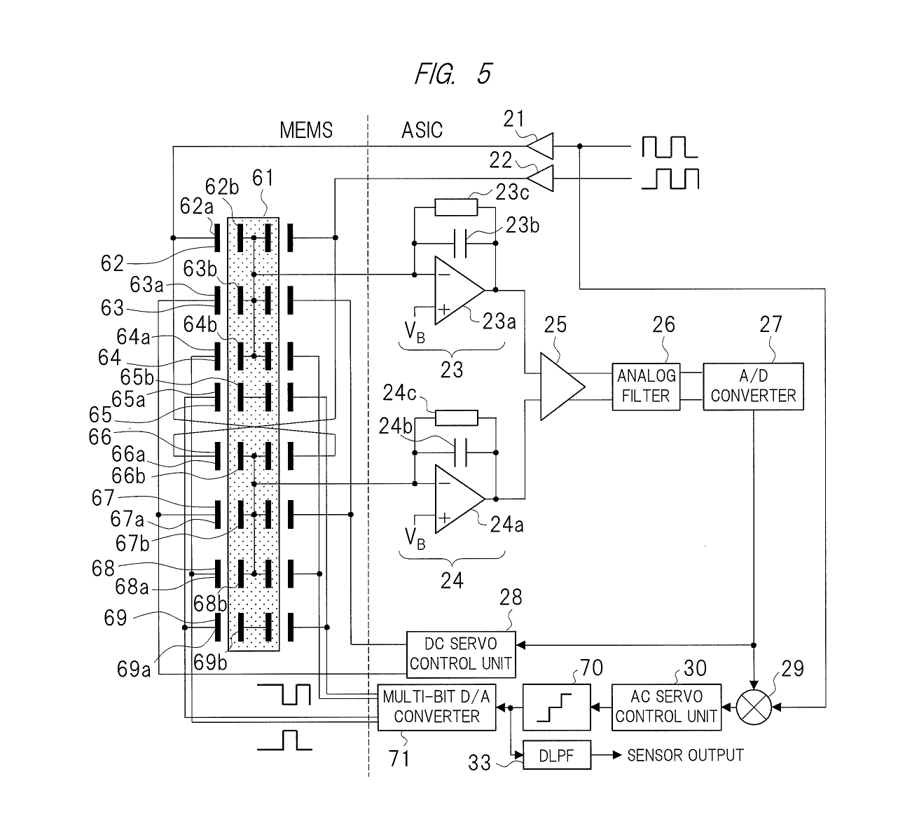

An acceleration sensor according to a fifth embodiment will be described with reference to FIG. 5. FIG. 5 is a diagram illustrating an example of a configuration of an acceleration sensor. The acceleration sensor according to the fifth embodiment will be described in an example of a servo configuration formed by “differential MEMS & common weight between differentials & differential amplifier & multi-valued D/A converter”. The fifth embodiment is different from the first to fourth embodiments in that the 1-bit quantizer and the 1-bit D/A converter of the ASIC are replaced with a multi-valued quantizer and a multi-valued D/A converter, which results in, for example, two sets of AC servo control capacitor pairs of the MEMS. In the fifth embodiment, a difference from the first to fourth embodiments will be mainly described.

In the MEMS, the positive-side acceleration detection element and the negative-side acceleration detection element are common with each other in a weight 61 between the differentials, and include signal detection capacitor pairs 62 and 66, DC servo control capacitor pairs 63 and 67, first AC servo control capacitor pairs 64 and 68, and second AC servo control capacitor pairs 65 and 69, respectively.

In the positive-side acceleration detection element, the signal detection capacitor pair 62 is provided with two pairs each including a fixed electrode 62a and a movable electrode 62b. Similarly, the DC servo control capacitor pair 63 is provided with two pairs each including a fixed electrode 63a and a movable electrode 63b. The AC servo control capacitor pairs 64 and 65 are provided with two sets of two pairs each including a pair of a fixed electrode 64a and a movable electrode 64b and a pair of a fixed electrode 65a and a movable electrode 65b in accordance with the multiple values.

Also in the negative-side acceleration detection element, a signal detection capacitor pair 66 (a fixed electrode 66a and a movable electrode 66b), a DC servo control capacitor pair 67 (a fixed electrode 67a and a movable electrode 67b), a first AC servo control capacitor pair 68 (a fixed electrode 68a and a movable electrode 68b), and a second AC servo control capacitor pair 69 (a fixed electrode 69a and a movable electrode 69b) have the same configurations as those of the positive-side acceleration detection element.

In the ASIC, drivers 21 and 22, charge amplifiers 23 and 24, an amplifier 25, an analog filter 26, an A/D converter 27, a DC servo control unit 28, a demodulator 29, and an AC servo control unit 30 have the same configurations as those of the first embodiment. The fifth embodiment includes a multi-valued quantizer 70 and a multi-valued D/A converter 71.

The multi-valued quantizer 70 has an input connected to the AC servo control unit 30 and has an output connected to the multi-valued D/A converter 71. The multi-valued quantizer 70 receives a servo value (AC component) determined by the AC servo control unit 30 as an input, and quantizes the servo value into multiple values (for example, as four values of 2 bits, 1.5, 0.5, −0.5, −1.5), and the multi-valued D/A converter 71 is combined with the configuration of the DC servo control capacitor, so that multi-valued voltages (for example, 7.5 V, 2.5 V, −2.5 V, −7.5 V) are outputted effectively. For example, in the case of 2 bits, +5 V/−5 V or −5 V/+5 V are applied to the two fixed electrodes (64a) of the AC servo control capacitor pair 64 based on a fact that a high-order bit value is either 1 or 0. The same application is also performed on the AC servo control capacitor pair 68. In addition, +5 V/−5 V or −5 V/+5 V are applied to the two fixed electrodes (65a) of the AC servo control capacitor pair 65 based on a fact that a low-order bit value is either 1 or 0. The same application is also performed on the AC servo control capacitor pair 69. Here, the setting of the capacitance values of the AC servo control capacitor pairs 65 and 69 to be ½ of the AC servo control capacitor pairs 64 and 68 can effectively bring the same state as that the voltages of four values of 7.5 V, 2.5 V, −2.5 V, and −7.5 V are applied to only any one set of the AC servo control capacitor pair as seen in FIG. 1 or others. As a matter of course, the number of sets of the AC servo control capacitor pair may be set to one as seen in FIG. 1 or others, and four voltages (7.5 V, 2.5 V, −2.5 V, and −7.5 V) may be practically outputted from the multi-valued D/A converter. In addition, various other achievement methods may be considered, and the number of bits may be larger than two bits.

The multi-valued D/A converter 71 has an input connected to the multi-valued quantizer 70 and has an output connected to the first AC servo control capacitor pairs 64 and 68 and the second AC servo control capacitor pairs 65 and 69. As described above, the multi-valued D/A converter 71 receives a multi-valued digital value quantized by the multi-valued quantizer 70 as an input, converts the digital value into an analog voltage, and applies the analog voltage to the fixed electrodes 64a and 68a of the first AC servo control capacitor pairs 64 and 68 and the fixed electrodes 65a and 69a of the second AC servo control capacitor pairs 65 and 69. In the multi-valued D/A converter 71, one (non-inverted) first output is applied to the fixed electrodes 64a and 68a on the right side in FIG. 5, and the other (inverted) first output is applied to the fixed electrodes 64a and 68a on the left side in FIG. 5, and besides, one (non-inverted) second output is applied to the fixed electrodes 65a and 69a on the right side in FIG. 5, and the other (inverted) second output is applied to the fixed electrodes 65a and 69a on the left side in FIG. 5. Note that the output of the multi-valued quantizer 70 is also inputted to a digital low-pass filter (DLPF) 33, and a high-frequency component (that is, quantization error noise-shaped (diffused) on a high-frequency side by a sigma-delta control of a servo loop) is suppressed by the DLPF 33, and the output of the DLPF 33 becomes a final output of the acceleration sensor.

As described above, at the time of the signal detection and the servo control, the multi-valued D/A converter 71 can convert the multi-valued digital value quantized by the multi-valued quantizer 70 into an analog voltage, and apply the analog voltage to the fixed electrodes 64a and 68a of the first AC servo control capacitor pairs 64 and 68 and the fixed electrodes 65a and 69a of the second AC servo control capacitor pairs 65 and 69.

Also in the above-described acceleration sensor according to the fifth embodiment, the simultaneous operation method of the signal detection and the servo control can be achieved as similar to the first embodiment. As a result, as an alternative to the time-division processing method, the simultaneous operation method of the signal detection and the servo control can be achieved, and therefore, the same effects as those of the first embodiment can be obtained. Furthermore, in the acceleration sensor according to the fifth embodiment, since the multi-valued quantizer 70 and the multi-valued D/A converter 71 are used, it is easier to design the stable operation than the case of using the 1-bit quantizer and the 1-bit D/A converter as described in the first to fourth embodiments, which results in the achievement of the noise reduction. However, the power consumption is increased and the MEMS is complicated by the usage.

In the configuration used in the multi-valued quantizer 70 and the multi-valued D/A converter 71 as described in the fifth embodiment, note that the charge amplifiers 23 and 24 of the ASIC can be changed from the operational amplifiers 23a and 24a to the fully differential operational amplifier as described in the third embodiment. That is, the acceleration sensor is an acceleration sensor having the servo configuration formed by “differential MEMS & common weight between differentials & fully differential amplifier & multi-valued D/A converter”.

### Sixth Embodiment

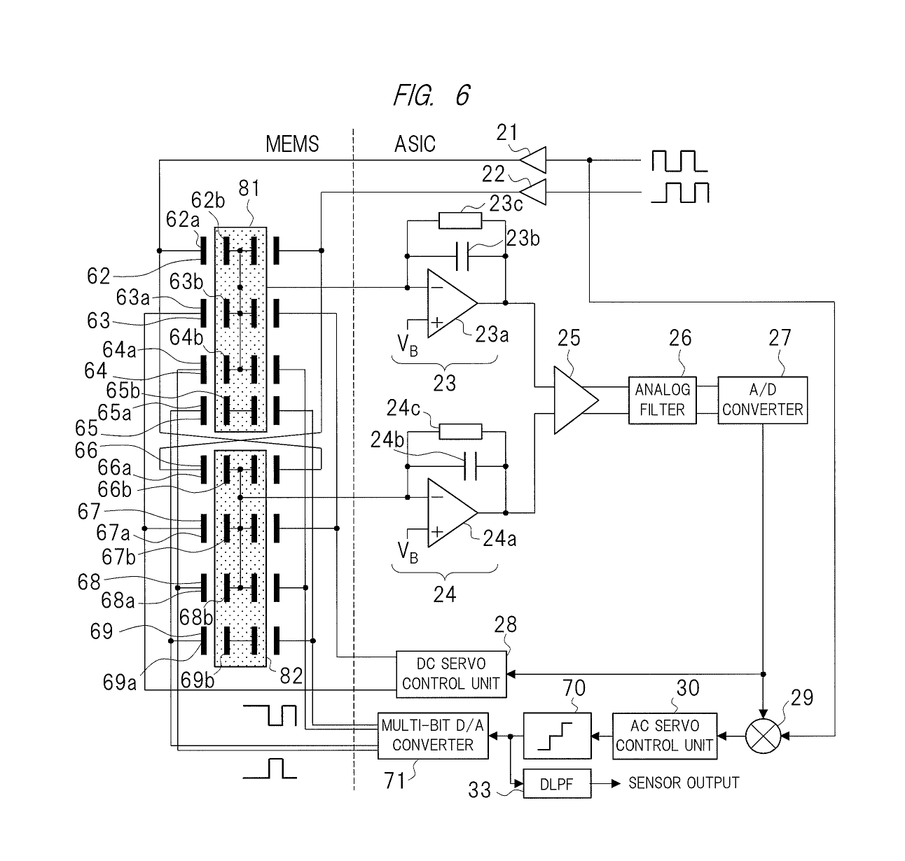

An acceleration sensor according to a sixth embodiment will be described with reference to FIG. 6. FIG. 6 is a diagram illustrating an example of a configuration of an acceleration sensor. The acceleration sensor according to the sixth embodiment will be described in an example of a servo configuration formed by “differential MEMS & different weight between differentials & differential amplifier & multi-valued D/A converter”. The sixth embodiment is different from the fifth embodiment in that the weight between the differentials is different between the positive-side acceleration detection element and the negative-side acceleration detection element of the MEMS. This is the same concept as that of the second embodiment.

In the MEMS, weights 81 and 82 are different from each other between the positive-side acceleration detection element and the negative-side acceleration detection element. The positive-side acceleration detection element has one weight 81, and the negative-side acceleration detection element has the other weight 82.

The positive-side acceleration detection element includes the weight 81, a signal detection capacitor pair 62, a DC servo control capacitor pair 63, a first AC servo control capacitor pair 64, and a second AC servo control capacitor pair 65. The negative-side acceleration detection element includes the weight 82, a signal detection capacitor pair 66, a DC servo control capacitor pair 67, a first AC servo control capacitor pair 68, and a second AC servo control capacitor pair 69.

In the above-described acceleration sensor according to the sixth embodiment, the simultaneous operation method of the signal detection and the servo control can be achieved as similar to the first embodiment. As a result, as an alternative to the time-division processing method, the simultaneous operation method of the signal detection and the servo control can be achieved, and therefore, the same effects as those of the first embodiment can be obtained. However, it is also necessary to devise the acceleration sensor according to the sixth embodiment as similar to the second embodiment.

In the configuration in which the weights 81 and 82 are provided so as to be different from each other between the positive-side acceleration detection element and the negative-side acceleration detection element and the multi-valued quantizer 70 and the multi-valued D/A converter 71 are used as described in the sixth embodiment, note that the charge amplifiers 23 and 24 of the ASIC can be changed from the operational amplifiers 23a and 24a to the fully differential operational amplifier as described in the fourth embodiment. That is, the acceleration sensor is the acceleration sensor having the servo configuration formed by “differential MEMS & different weight between differentials & fully differential amplifier & multi-valued D/A converter”.

### Seventh Embodiment

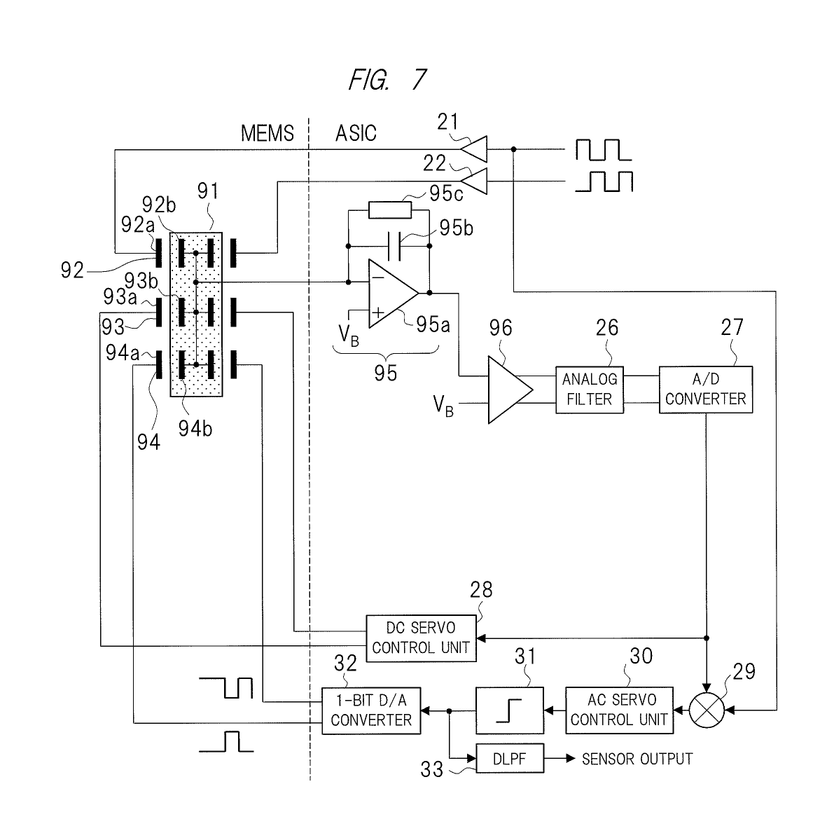

An acceleration sensor according to a seventh embodiment will be described with reference to FIG. 7. FIG. 7 is a diagram illustrating an example of a configuration of an acceleration sensor. The acceleration sensor according to the seventh embodiment will be described in an example of a servo configuration formed by “single MEMS”. The seventh embodiment is different from the first to sixth embodiments in that the MEMS has a single structure. In the seventh embodiment, a difference from the first to sixth embodiments will be mainly described.

In the MEMS, an acceleration detection element includes a weight 91, a signal detection capacitor pair 92, a DC servo control capacitor pair 93, and an AC servo control capacitor pair 94. In the acceleration detection element, the signal detection capacitor pair 92 is provided with two pairs each including a fixed electrode 92a and a movable electrode 92b. Similarly, the DC servo control capacitor pair 93 is provided with two pairs each including a fixed electrode 93a and a movable electrode 93b. Similarly, the AC servo control capacitor pair 94 is provided with two pairs each including a fixed electrode 64a and a movable electrode 94b.

In the ASIC, drivers 21 and 22, an analog filter 26, an A/D converter 27, a DC servo control unit 28, a demodulator 29, an AC servo control unit 30, a 1-bit quantizer 31, and a 1-bit D/A converter 32 have the same configurations as those of the first embodiment. The seventh embodiment includes a charge amplifier 95 and an amplifier 96.

The charge amplifier 95 is a C/V conversion circuit that includes an operational amplifier 95a, and a feedback capacitor 95b and a high-resistance resistor 95c, which are connected in parallel between an input and an output of the operational amplifier 95a. The charge amplifier 95 has an input connected to the movable electrodes 92b, 93b, and 94b and has an output connected to the amplifier 96. In the operational amplifier 95a, signals from the movable electrodes 92b, 93b, and 94b are inputted to an inverted input (−), and the reference voltage V_{B} is applied to a non-inverted input (+). The charge amplifier 95 converts a capacitance change value between the fixed electrode 92a and the movable electrode 92b, which is proportional to the displacement of the weight 91 generated by the application of the acceleration, into a voltage, and outputs the voltage to the amplifier 25.

In the amplifier 96, one input is connected to the charge amplifier 95, the reference voltage V_{B} is applied to the other input, and an output is connected to the analog filter 26. The amplifier 96 receives the voltage converted by the charge amplifier 95 and the reference voltage V_{B} as inputs, performs differential amplification based on these voltages, and outputs the differentially-amplified voltage to the analog filter 26.

In the above-described configuration, a voltage that generates a force in a direction opposite to a detection signal of acceleration detected by the signal detection capacitor pair 92 is applied to the DC servo control capacitor pair 93 and the AC servo control capacitor pair 94 during the detection of the detection signal. Therefore, in the present embodiment, the simultaneous operation method of the signal detection and the servo control can be achieved. Furthermore, since different voltages from each other can be applied to the DC servo control capacitor pair 93 and the AC servo control capacitor pair 94, the servo voltage (DC component) and the servo voltage (AC component) can be individually controlled.

In the above-described acceleration sensor according to the seventh embodiment, the simultaneous operation method of the signal detection and the servo control can be achieved as similar to the first embodiment. As a result, as an alternative to the time-division processing method, the simultaneous operation method of the signal detection and the servo control can be achieved, and therefore, the same effects as those of the first embodiment can be obtained. That is, even in the single MEMS configuration according to the seventh embodiment, the same effects as those of the first embodiment can be obtained. However, as different from the case of the differential MEMS configuration, the electric signal generated by the displacement of the movable electrode part (that is, the weight) of the DC servo control capacitor pair 93 or the AC servo control capacitor pair 94 is superimposed on the original detection signal, and therefore, noise is not reduced as much as that of the first embodiment. Instead, lower power consumption and a smaller mounting size can be achieved because of the simple configuration.

In the structure in which the MEMS has the single configuration as described in the seventh embodiment, note that the 1-bit quantizer 31 and the 1-bit D/A converter 32 of the ASIC can be replaced with a multi-valued quantizer and a multi-valued D/A converter as described in the fifth embodiment. That is, the acceleration sensor is the acceleration sensor having the servo configuration formed by “single MEMS & multi-valued D/A converter”.

In the foregoing, the invention made by the present inventors has been concretely described based on the embodiments. However, it is needless to say that the present invention is not limited to the foregoing embodiments and various modifications and alterations can be made within the scope of the present invention.

The above-described embodiments have been explained for easily understanding the present invention, but are not always limited to the ones including all structures explained above. Also, a part of the structure of one embodiment can be replaced with the structure of the other embodiment, and besides, the structure of the other embodiment can be added to the structure of one embodiment. Further, the other structure can be added to/eliminated from/replaced with a part of the structure of each embodiment.

For example, in the embodiments, the configuration that includes the DC servo control capacitor pair and the AC servo control capacitor pair as the servo control capacitor pairs in the MEMS has been described. However, the present invention can also be applied to the case including only the AC servo control capacitor pair. In this case, the DC servo control unit is unnecessary also in the ASIC, and only the AC servo control unit or others may be included. The AC servo control capacitor pair and the AC servo control unit can collectively handle both the DC component and the AC component of the input acceleration signal.

What is claimed is:

1. An acceleration sensor of a MEMS capacitive type comprising:
a first capacitor pair for signal detection; and
a second capacitor pair for servo control, which is different from the first capacitor pair,
wherein a voltage, that generate a force in a direction opposite to a detection signal of acceleration detected by the first capacitor pair, is applied to the second capacitor pair.

2. The acceleration sensor according to claim 1,
wherein the voltage, that generate the force in the direction opposite to the detection signal of acceleration detected by the first capacitor pair, is applied to the second capacitor pair during the detection of the detection signal.

3. The acceleration sensor according to claim 1 further comprising a third capacitor pair for DC component servo control and a fourth capacitor pair for AC component servo control as the second capacitor pair,
wherein different voltages from each other are applied to the third capacitor pair and the fourth capacitor pair, respectively.

4. The acceleration sensor according to claim 1, further comprising a fifth capacitor pair for positive-side signal detection and a sixth capacitor pair for negative-side signal detection as the first capacitor pair,
wherein the detection of the acceleration by the fifth capacitor pair and the sixth capacitor pair is a differential detection that receives a positive-side detection signal detected by the fifth capacitor pair and a negative-side detection signal detected by the sixth capacitor pair as inputs.

5. The acceleration sensor according to claim 4,
wherein a weight of the fifth capacitor pair and a weight of the sixth capacitor pair are different from each other.

6. The acceleration sensor according to claim 4,
wherein a weight of the fifth capacitor pair and a weight of the sixth capacitor pair are the same as each other.

7. The acceleration sensor according to claim 4,
wherein the detection of the acceleration detected by the fifth capacitor pair and the sixth capacitor pair is a fully differential detection that receives a positive-side detection signal detected by the fifth capacitor pair and a negative-side detection signal detected by the sixth capacitor pair as inputs.

8. The acceleration sensor according to claim 1, further comprising a seventh capacitor pair for DC component servo control and a plurality of eighth capacitor pairs for AC component servo control as the second capacitor pair,
wherein voltages, which are different from a voltage applied to the seventh capacitor pair and are generated based on multi-valued quantization, are applied to the plurality of eighth capacitor pairs, respectively.

9. The acceleration sensor according to claim 1 comprising:
a first servo control circuit for applying a voltage, that generates a force in a direction opposite to a detection signal of acceleration detected by the first capacitor pair, to the second capacitor pair.

10. The acceleration sensor according to claim 9,
wherein the first servo control circuit applies the voltage, that generates the force in the direction opposite to the detection signal of acceleration detected by the first capacitor pair, to the second capacitor pair during the detection of the detection signal.

11. The acceleration sensor according to claim 3, further comprising:
a second servo control circuit for applying a first voltage to the third capacitor pair; and
a third servo control circuit for applying a second voltage to the fourth capacitor pair, the second voltage being different from the first voltage.

12. The acceleration sensor according to claim 4, further comprising a differential detection circuit that receives a positive-side detection signal detected by the fifth capacitor pair and a negative-side detection signal detected by the sixth capacitor pair as inputs and that performs differential detection.

13. The acceleration sensor according to claim 7, further comprising a differential detection circuit that receives a positive-side detection signal detected by the fifth capacitor pair and a negative-side detection signal detected by the sixth capacitor pair as inputs and that performs fully differential detection.

14. The acceleration sensor according to claim 8, further comprising:
a fourth servo control circuit for applying a third voltage to the seventh capacitor pair; and
a fifth servo control circuit for applying fourth voltages, which are different from the third voltage and are generated based on multi-valued quantization, to the plurality of eighth capacitor pairs, respectively.
